(19) United States
(12) Patent Application Publication
(10) Pub. No.: US 2010/0024143 A1
(43) Pub. Date: Feb. 4, 2010

(54) TOOTHBRUSH INCORPORATING TRAINING AID

(76) Inventor: Robert G. Dickie, King City (CA)

Correspondence Address: SAND & SEBOLT, AEGIS TOWER, SUITE 1100, 4940 MUNSON STREET, NW, CANTON, OH, 44718-3615, US

(21) Appl. No.: 12/543,992

(22) Filed: Aug. 19, 2009

Related U.S. Application Data
(63) Continuation-in-part of application No. 12/137,846, filed on Jun. 12, 2008.

(51) Int. Cl. A46B 9/04; G06F 17/00

(52) U.S. Cl. 15/167.1; 700/90

(57) ABSTRACT

A toothbrush and method of use for improving oral health habits. A plurality of light assemblies and an overlay including appealing graphics are provided on the toothbrush with some of the graphics disposed adjacent the assemblies. A microprocessor carries software that tracks actual brushing time over a plurality of brushing events in a pre-set time period. The total brushing time during that time period is compared with a preferred brushing time and a proportionate number of the light assemblies are illuminated to indicate the degree of brushing compliance.

### CROSS-REFERENCE TO RELATED APPLICATIONS

This is a Continuation-in-Part of U.S. patent application Ser. No. 12/137,846, filed Jun. 12, 2008, the entire specification of which is incorporated herein.

### BACKGROUND OF THE INVENTION

1. Technical Field

This invention generally relates to toothbrushes. More particularly, the invention relates to a child's toothbrush. Specifically, the invention relates to a toothbrush incorporating a training aid to motivating a child to increase their brushing time and assists a parent in monitoring their child's brushing habits.

2. Background Information

Parents frequently experience problems with children who are reluctant not only to brush their teeth, but also to brush their teeth for a sufficient length of time. The American Dental Association (hereinafter ADA) recommends that everyone should brush their teeth twice a day for two minutes each time. Statistics show that even adults average only forty-five seconds of brushing and the average time period children spend on brushing their teeth is even lower. Many parents are aware that their children do not brush their teeth for a sufficiently long time but it is difficult for parents to monitor every brushing as it is time consuming and may tend to create anxiety for the child and potential battle grounds between parents and the child. Various devices and methodologies have been utilized in the prior art in an attempt to address this issue and to encourage children to continue brushing longer than they would normally choose. One such methodology has included the provision of specially designed tablets that, when dissolved in the mouth, produce a color in all regions of the teeth where plaque remains. The tablets provide the child with an easily detected visual aid that clearly shows that they need to continue brushing until all of the color on the teeth is removed.

Additionally, a wide variety of toothbrushes have been provided in the art that include mechanisms for advising the user how long they have actually been brushing their teeth. This is why so many powered toothbrushes have timers that are set for a two minute interval. Once brushing commences, the timer is activated and, when the two minute interval is over, the brush emits some sort of signal. For example, as disclosed in U.S. Pat. No. 6,029,303 to Dewan, when the pre-set length of time is over, the toothbrush emits an audible sound or a visual signal, such as a flashing light. This audible sound or flashing light is emitted immediately after brushing has ceased and indicates to the user that the predetermined amount of time for brushing their teeth has been reached and they can stop brushing their teeth. If the user does not brush their teeth for long enough, no signal will be generated by the brush to let the user know they have brushed for the preferred amount of time, i.e., no sound will be emitted and no light will flash. The system disclosed by Dewan is essentially an immediate-reward type of system. The preferred action of brushing the teeth for a specified length of time is rewarded by the toothbrush emitting a sound or displaying a flashing light. If the preferred action is not completed, i.e., if the person doesn't brush long enough, there is no reward. Dewan's device may include a timer that monitors cumulative brushing time and then causes a signal to be emitted once the useful life of the toothbrush is over.

Another toothbrush disclosed in the prior art is the brush shown in PCT Publication No. WO 2006/065159 to Jeziorowski. This brush includes sensors under the bristles that are linked to a timer for recording the actual time the bristles are in contact with the teeth during brushing. Every time the bristles are lifted out of contact with the teeth, the timer stops and when contact is resumed, the timer restarts. After a pre-set period of time has elapsed, such as three minutes, an audible sound is emitted by the brush. The time elapsed is displayed in numbers and bars on a digital display in the handle. The brush also accumulates a record of the total time the bristles have been in use and indicates when the bristles have ended their useful life by displaying an indicator on the handle or by making a distinctive sound.

U.S. Pat. No. 5,704,087 to Strub is directed to a toothbrush that includes a processor which tracks a long period of time, such as a six-month period, and then emits a signal to advise the user that it is time to visit the dentist. The signal may take the form of an audible sound or a flashing light that is emitted by the brush each time it is used after the six-month period has elapsed.

U.S. Pat. No. 5,438,726 to Leite discloses a toothbrush that includes a display screen which displays a time period in numbers. The numbers count down a pre-determined time period. When the numbers reach zero, the toothbrush emits an audible sound or vibrates to signal to the user that the time period for brushing teeth has ended.

U.S. Pat. No. 7,013,522 to Kumagai discloses a toothbrush that generates sounds in response to the movement made by the toothbrush during brushing. The brush also includes a counter that records the number of movements made during brushing. The counter is linked to the sound generating components so that a variety of sounds or messages are emitted from the brush to encourage the user to continue brushing their teeth. The messages change as the count number goes up.

U.S. Pat. No. 5,561,881 to Klinger et al discloses a toothbrush including a timer for tracking time, pressure sensors for tracking pressure applied during brushing and a positioning sensor for tracking the orientation of the brush during brushing. The brush further includes a processor for computing all of this information and giving a visual indication on a screen as to the effectiveness of the user's brushing action.

Finally, U.S. Publication No. 2002/0133308 to Lundell et al, discloses a toothbrush that includes an electric toothbrush and a separate control unit having a microprocessor that collects and stores data relating to actual brushing times and the condition of the toothbrush battery. The control unit may include a display screen to show the status of the toothbrush.

While all of these devices and methodologies work to varying degrees, they are not necessarily fun experiences for a child who just wants the brushing tedium to be over.

There is therefore a need in the art for an improved device and method to encourage younger children to continue brushing for a set period of time and to improve their oral care by incorporating other oral health tools and devices.

### SUMMARY OF THE INVENTION

A toothbrush and method of use for improving the oral health habits of a child are disclosed. A plurality of light assemblies and an overlay including appealing graphics are provided on the toothbrush with some of the graphics disposed adjacent the assemblies. A microprocessor carries software that tracks actual brushing time over a plurality of brushing events in a pre-set time period. The total brushing time during that time period is compared with a preferred brushing time and a proportionate number of the light assemblies are illuminated to indicate the degree of brushing compliance.

### BRIEF DESCRIPTION OF THE DRAWINGS

The preferred embodiment of the invention, illustrative of the best mode in which applicant has contemplated applying the principles, is set forth in the following description and is shown in the drawings and is particularly and distinctly pointed out and set forth in the appended claims.

FIG. 1 is a front view of a toothbrush in accordance with the present invention;

FIG. 2 is a partial block diagram illustrating the circuitry contained within the toothbrush of the present invention;

FIG. 3 is an enlarged view of the display of the electronic pet provided on the front of the toothbrush and showing the virtual pet in an initial mode prior to the child starting to brush their teeth;

FIG. 4 is an enlarged view of the display showing the second stage of the virtual pet once a first time period of brushing has elapsed;

FIG. 5 is an enlarged view of the display showing the third stage of the virtual pet once a second time period of brushing has elapsed;

FIG. 6 is an enlarged view of the display showing the fourth stage of the virtual pet once a third time period of brushing has elapsed;

FIG. 7 is an enlarged view of the display showing the fifth stage of the virtual pet once a fourth time period of brushing has elapsed;

FIG. 8 is an enlarged view of the display showing the sixth stage of the virtual pet once a fifth time period of brushing has elapsed;

FIG. 9 is an enlarged view of the display showing the seventh stage of the virtual pet once a sixth time period of brushing has elapsed;

FIG. 10 is an enlarged view of the display showing the eighth stage of the virtual pet once a seventh time period of brushing has elapsed;

FIG. 11 is an enlarged view of the display showing the ninth stage of the virtual pet once an eighth time period of brushing has elapsed;

FIG. 12 is an enlarged view of the display showing the tenth stage of the virtual pet once a ninth time period of brushing has elapsed;

FIG. 13 is an enlarged view of the display showing the second stage of the virtual pet once a tenth time period of brushing has elapsed;

FIG. 14, is an enlarged view of the display showing the twelfth stage of the virtual pet once an eleventh time period of brushing has elapsed;

FIG. 15 is an enlarged view of the display showing the final stage of the virtual pet once a twelfth time period of brushing has elapsed;

FIG. 16 is a front view of the toothbrush of FIG. 1 shown incorporated into packaging for retail sales;

FIG. 17 is a rear view of the packaged toothbrush of FIG. 16;

FIG. 18 is front elevational view of a second embodiment of an electric toothbrush incorporating a training aid in accordance with the present invention;

FIG. 19 is a side view of the toothbrush of FIG. 18;

FIG. 20a is a partial cross-sectional view of a first version of the front wall of the toothbrush taken through line 20-20 of FIG. 18;

FIG. 20b is a partial cross-sectional view of a second version of the front wall of the toothbrush taken through line 20-20 of FIG. 18;

FIG. 21 is a block diagram illustrating the circuitry contained within the toothbrush of FIG. 18;

FIG. 22 is a front elevational view of the toothbrush showing an overlay applied adjacent a portion of the handle of the toothbrush and showing a plurality of graphic images thereon; and

FIG. 23 is a side view of the toothbrush of FIG. 22.

### DETAILED DESCRIPTION OF THE INVENTION

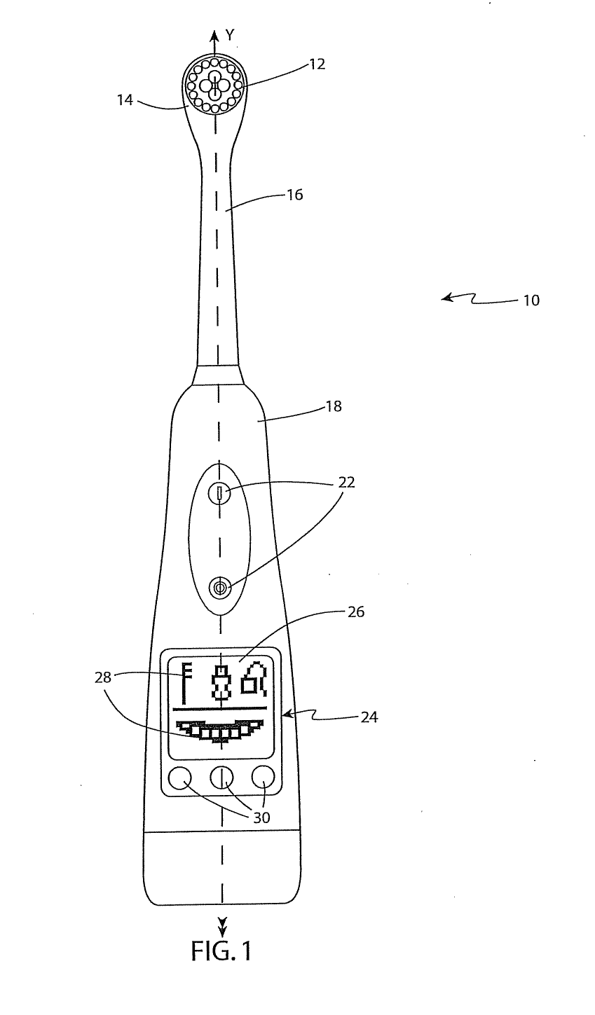

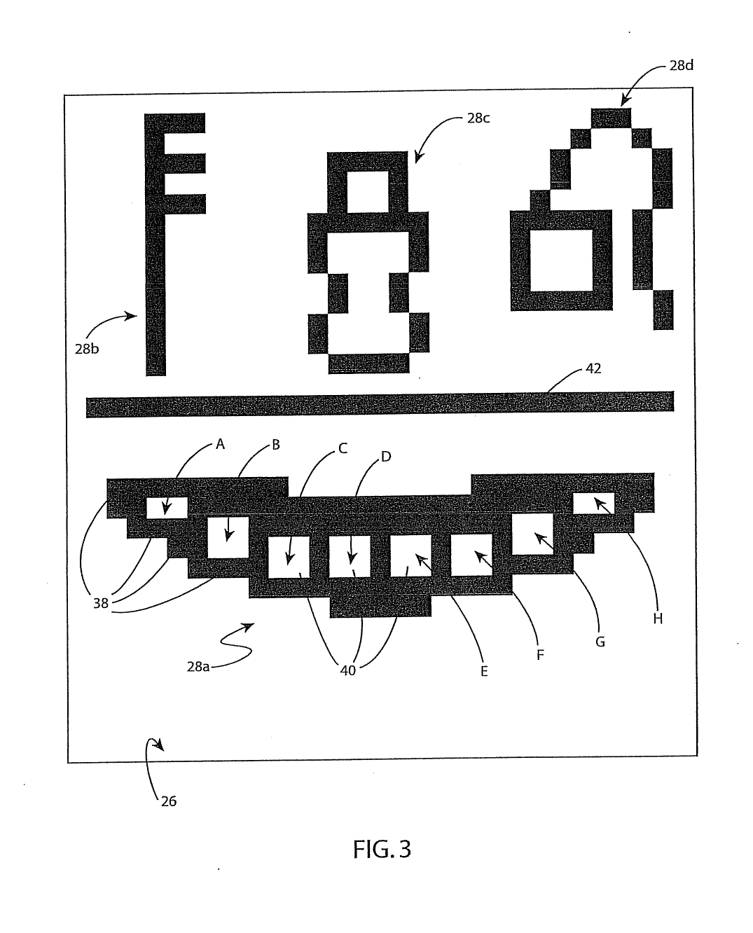

Referring to FIG. 1 there is shown a toothbrush in accordance with the present invention and generally indicated at 10. Toothbrush 10 is a powered toothbrush that has a plurality of movable bristles 12 on a head 14 at one end of a neck 16. The neck 16 is connected to a handle 18 that retains a power source 20 (FIG. 3) therein. Toothbrush 10 preferably is of a type in which bristles 12 are caused to move by said power source 20. So, for example, bristles 12 may be rotated, or may be reciprocated (not illustrated) back and forth in an orientation generally parallel to a longitudinal axis “Y” of toothbrush 10. Toothbrush 10 is provided with activator buttons 22 to start and stop the motion of bristles 12.

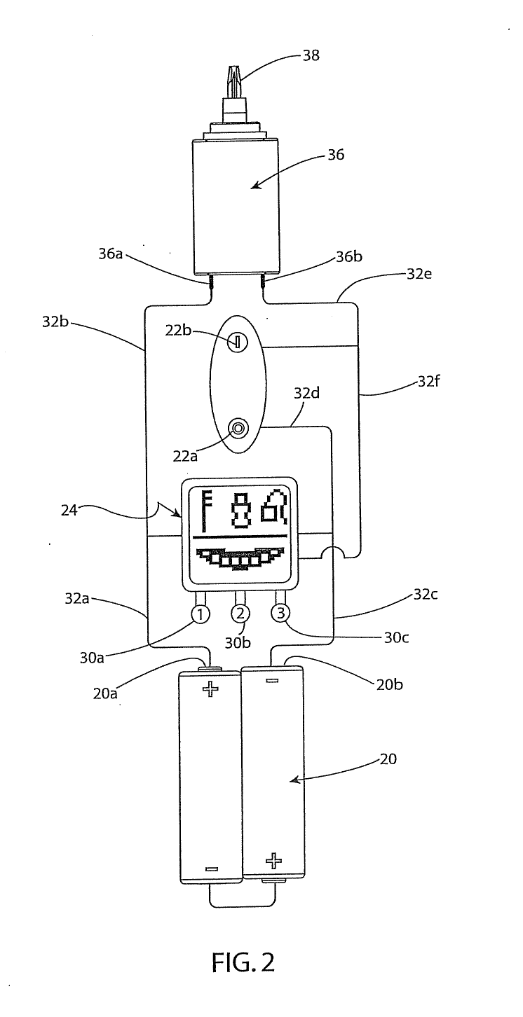

In accordance with a specific feature of the present invention, toothbrush 10 includes a digital training aid 24 that is incorporated into handle 18 and is provided as a means for motivating a child to take better care of their teeth. More specifically, digital training aid 24 is provided to aid in increasing the length of time that the child brushes their teeth and to encourage them to use other oral care products, such as floss and mouthwash to improve their oral health. Training aid 24 includes a display screen 26, a microprocessor 134 (FIG. 2) and one or more play buttons 30 to activate microprocessor 34. Training aid 24 preferably is of a type similar to that sold under the trademark Tamagotchi by Kabushiki Kaisha Bandai of Tokyo, Japan. These digital toys include a small microprocessor and a monochrome display screen with three or four play buttons. The display screen shows an image of a virtual pet. The toys also include an internal clock and require the user depress the play buttons to input various tasks at various times to keep the pet displayed on the screen healthy and happy. The display will indicate that it is time to feed, brush or pat the virtual pet and the user will select an appropriate tool or item on the display screen to accomplish this task. So, for example, if display indicates that it is time to feed the pet, the user will push the appropriate button to select a food bowl displayed on the screen. If this action is taken in an allotted time, the pet remains healthy and happy. If the action is not taken in the allotted time, the pet's health and happiness deteriorates. These digital toys include a health and happiness meter on the screen to show the status of the pet. Only if all the required actions are taken in a timely fashion does the pet remain healthy and happy and only then can the user play a plurality of fun games available on the microprocessor. Children learn to check and care for their digital pet so that they can keep it happy and so that they can play the games available in the device.

The toothbrush 10 of the present invention incorporates this type of digital toy, but instead of images relating to virtual pets and the care thereof, microprocessor 34 includes software that generates images 28 that relate to teeth and to oral health. Images 28 preferably are of a pictorial nature and represent objects such as a smile 28a with teeth A-H, a toothbrush 28b, a mouthwash container 28c, and a dental floss container 28d. Images 28 preferably are substantially free of letters and numbers as they are designed to be easily understood and interpreted, even by children that are unable to read or to identify numbers. It will be understood, however, that numbers and letters may be displayed on screen 26 in addition to images 28. Pictorial images 28a, 28b, 28c and 28d displayed on display screen 26 are by way of example only. Any graphic image that would be appealing to a child and that represents some type of oral care product or relates to the teeth or mouth could be used without departing from the present invention. FIG. 2 shows the major components of toothbrush 10 and includes possible electrical circuit 32 to link those components to each other and to a power source 20. In the system illustrated, a pair of batteries is used as power source 20. A first section 32a of circuit 32 links a terminal 20a on one of the batteries to microprocessor 34 for the digital training aid 24. A second section 32b of circuit 32 links terminal 20a to a first contact 36a on a motor 36. A third section 32c of circuit 32 links a terminal 20b on the other of the batteries to microprocessor 34. Terminal 20b on the other of the batteries is also linked to a terminal 22a on the on-off switch 22 by a fourth section 32d of circuit 32. A fifth section 32e of circuit 32 links a second terminal 22b on the on-off switch 22 to a second contact 36b on motor 36. A feedback section 32f of circuit 32 extends between second contact 36b and microprocessor 34. It will be seen that motor 36 and microprocessor 34 are connected into circuit 32 in parallel. Additionally, motor 36, switch 22 and microprocessor 34 are connected in series. Microprocessor 34 includes a clock (not shown). When the batteries are placed in toothbrush 10, the clock is always on, but display screen 26 is blank. Touching any of buttons 30 or the on/off controls of switch 22 turns display screen 26 on. Play buttons 30a, 30b and 30c are directly wired to microprocessor 34. Each button 30 is associated with one of the images that appear above line 42. So, for example, button 30a is associated with toothbrush 28b, button 30b is associated with mouthwash container 28c and button 30c is associated with floss container 28d. Buttons 30a-30c are used to input data into microprocessor and to play games stored therein.

Microprocessor 34 is the brains of digital training aid 24 and is programmed to accumulate data, process the same and cause the display of images 28 on display screen 26. Microprocessor 34 is programmed to sense and track the cumulative amount of actual brushing time as measured by the actual run-time of motor 36. It is also programmed to record the frequency of the operation of motor 36. Specifically, microprocessor 34 is programmed to track frequency and the actual run-time of motor 36 for a period of at least twenty-four hours and to display images 28 in accordance with data gathered and processed over that time period. Furthermore, the software is designed to compare the frequency and actual run-time data with a pre-set preferred frequency and run-time for motor 36. Microprocessor 34 also tracks and records input from buttons 30b and 30c which are depressed each time the child has used other oral care products, specifically mouthwash and dental floss, in the twenty-four-hour period. Still other software in microprocessor 34 relates to games that are available as a reward to the child for meeting the pre-set brushing and oral care goals.

The ADA has recommended that teeth be brushed a minimum of two times a day for a minimum of two minutes each time. This frequency and time period are programmed into microprocessor 34 as the pre-set preferred frequency and run-time for motor 36. Microprocessor 34 compares the actual period of brushing time with this preferred, and pre-programmed, time and generates smile 28a according to the relationship between these two times.

When toothbrush 10 is to be used, the on-button 22b of switch 22 is depressed, closing circuit 32. Motor 36 is actuated and causes motion in a drive shaft 38 that extends outwardly therefrom. Drive shaft 38, in turn, produces motion in bristles 12. When off-button 22a is engaged and on-button 22b is therefore disengaged, motor 36 ceases to run. Microprocessor 34 is linked, via feedback circuit 32f with on-button 22b and, consequently, engagement of on-button 22b causes circuit 32f to be closed and microprocessor 34 to be actuated to begin gathering information about the length of time motor 36 runs. Disengagement of on-button 22b breaks circuit 32f and microprocessor 34 records the cessation of motor 36. Microprocessor 34 therefore gathers information about the actual run-time of motor 36 between the time of engagement of on-button 22b and the disengagement thereof. Microprocessor 34 gathers this information each time toothbrush 10 is used in a time period of at least twenty-four hours. The frequency of use of toothbrush for brushing is also recorded. Microprocessor 34 is programmed to compare this gathered information with the pre-programmed preferred frequency and run-time of motor 36. Images 28 are generated in response to the comparison of actual frequency and actual run-time with preferred frequency and preferred run-time as will be hereinafter described.

Referring to FIG. 3, image 28 on display screen 26 includes smile 28a showing eight “teeth” numbered A through H. Each tooth comprises a block-type representation having a darker border region 38 and a lighter interior region 40. Image 28 further includes a second image being a pictorial representation of a toothbrush 28b. Image 28 further includes a third image being a pictorial representation of a mouthwash container 28c and a fourth image being a pictorial representation of a dental floss container 28d with a length of floss extending outwardly away therefrom. A line 42 extends across display screen and separates smile 28a from the three spaced-apart images of toothbrush 28b, mouthwash container 28c and a floss container 28d. The overall impression of image 28 is that of a face with the eyes being image 28b and 28d, the nose being image 28c and the mouth being image 28a. It will be understood that the image 28 shown in FIG. 3 is by way of illustration only and the designs and arrangement of the images 28b-28d can be altered, and that smile 28a can have any number of “teeth” preferred, without departing from the spirit of the present invention.

Smile 28a acts as a meter for displaying the length of time the teeth were actually brushed relative to the preferred period of time they should have been brushed. In FIG. 3, smile 28a includes all of teeth A-H and this is the image that is displayed on display screen 26 when toothbrush 10 is first used. The images of toothbrush 28b, mouthwash container 28c and dental floss container 28d are representative images that are individually selected by the child when they have physically used the associated product in their own dental care routine. The child selects the relevant image by depressing the associated play button 30a-30c. Images 28b, 28c and 28d are always displayed on display screen 26.

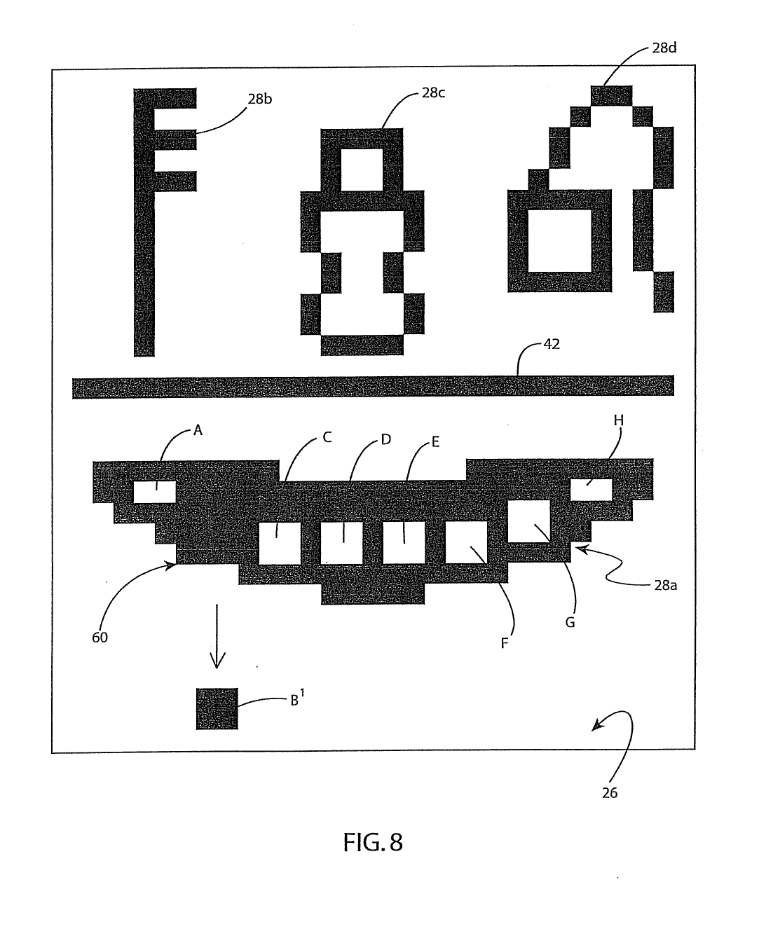

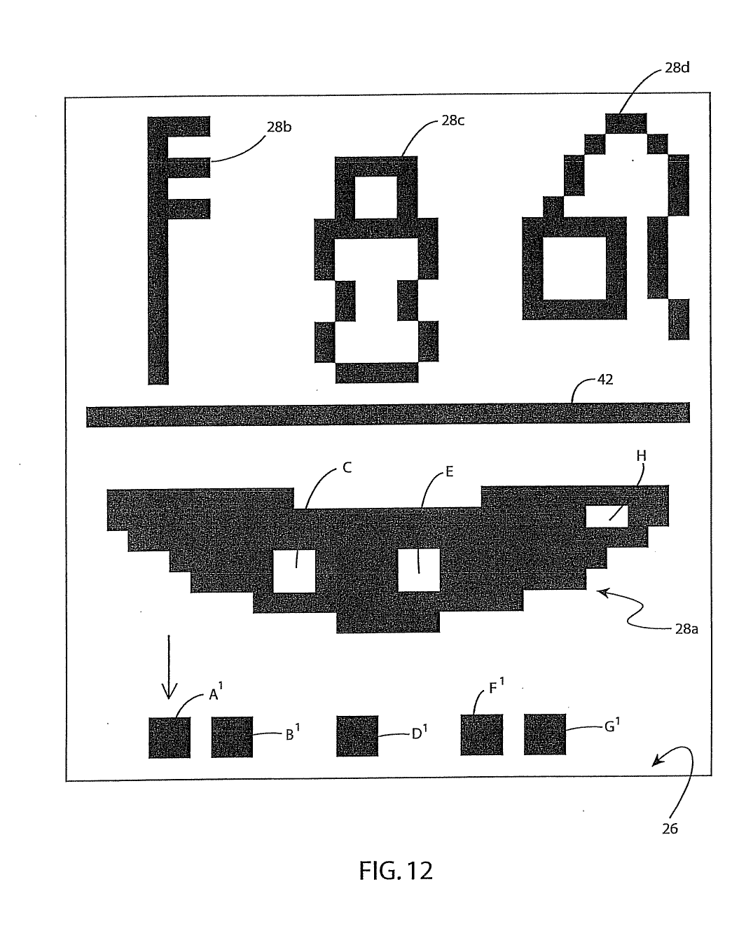

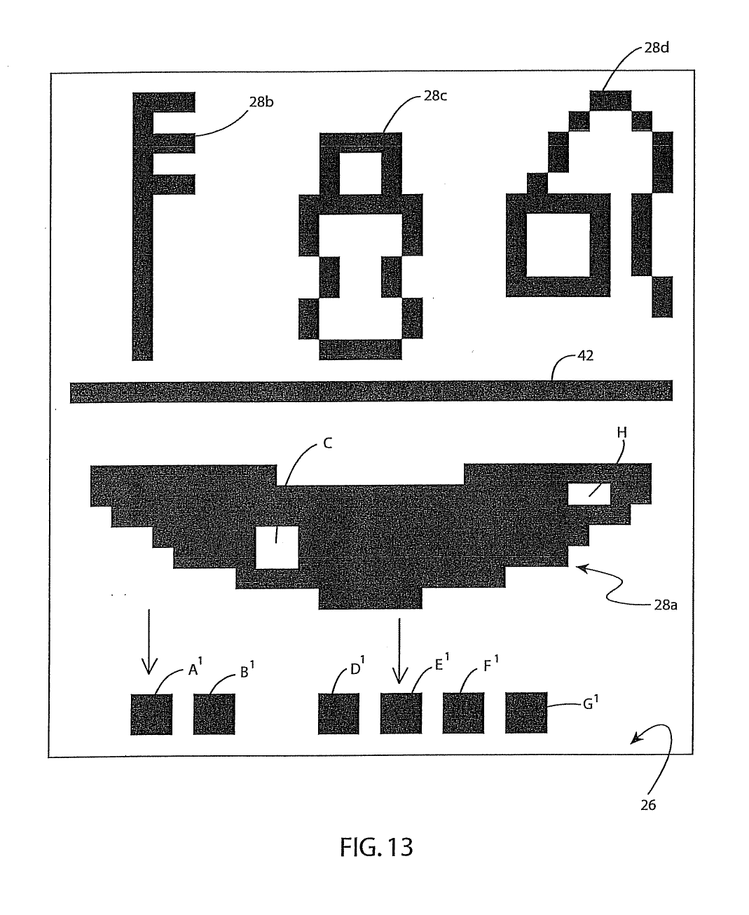

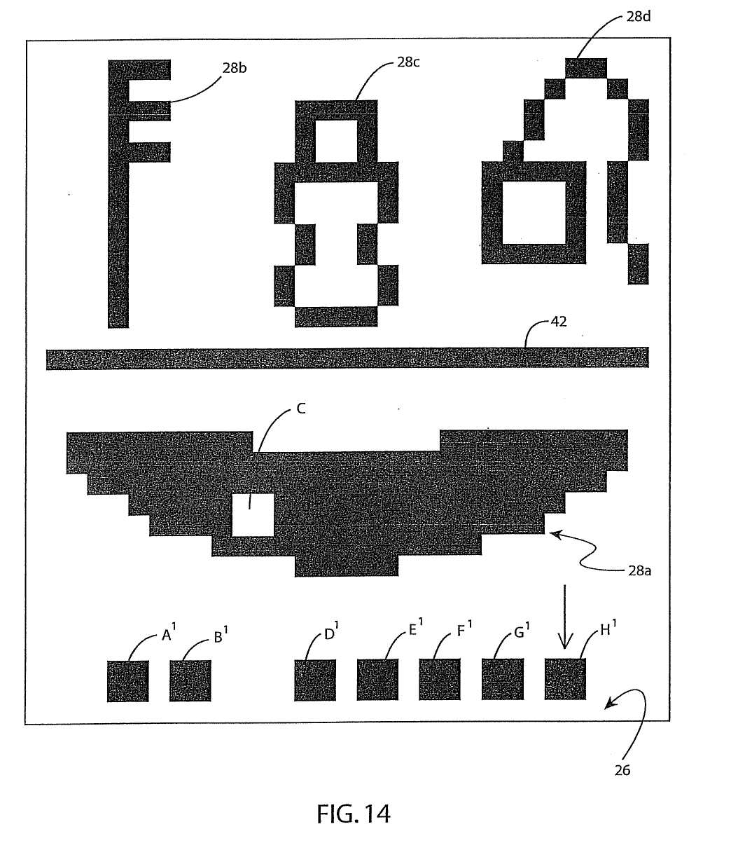

FIGS. 3 to 15 show a plurality of enlarged display screens 26 to illustrate how image 28 changes in response to microprocessor 34 processing the actual brushing time, brushing frequency and additional oral care information that is input. Smile image 28a is programmed in real time as microprocessor 34 is linked to the on-button 22b of switch 22 that activates and deactivates motor 36. When the child engages switch 22 to start motor 36 and thereby move bristles 12, the microprocessor 34 records exactly when the motor was activated and for how long the motor 36 runs. The microprocessor 34 will track this information for a pre-set period of time being at least twenty-four hours, and will provide a visual “report card” of that brushing period. By regular brushing alone, the smile image 28a can be maintained with all of its teeth intact, i.e., image 28a can look like that shown in FIG. 3, provided the actual run-time and frequency over the pre-set time period of twenty-four to forty-either hours meets or exceeds the preferred run-time and frequency programmed into microprocessor 34. A parent can simply touch any button on the toothbrush 10 to activate display screen 26 and view smile 28a to see the exact status of the child's brushing habits over that twenty-four to forty-eight hours. Brushing less than twice a day and less than two minutes a time will cause the smile 28a to change by having “teeth” fall out of smile 28a as will be hereinafter described with reference to FIGS. 8 to 15. It is therefore easy for a parent to see if their child is not brushing teeth for a sufficient period of time.

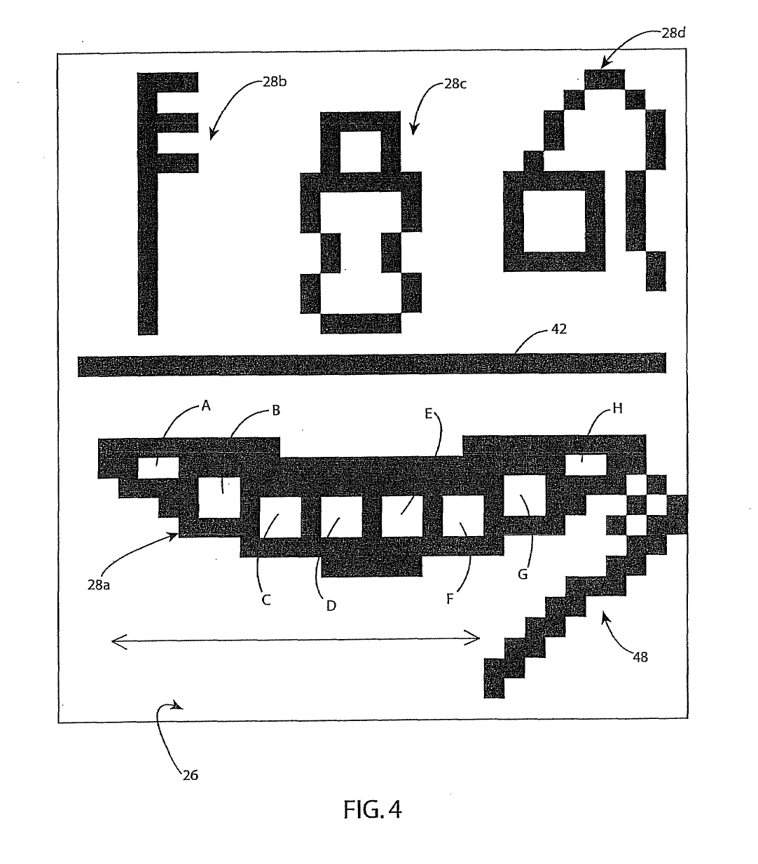

FIG. 4 shows changes in display screen 26 when motor 36 is activated by closing switch 22. The child may depress play button 28b when they intend to start brushing their teeth. This is not essential as simple activation of motor 36 transmits a signal via the feedback circuit 32f to microprocessor 34. When motor 36 is activated, microprocessor 34 causes an additional image to appear on display screen 26. This additional image is one of a manual toothbrush 48 that appears below line 42 and proximate smile 28a. Manual toothbrush 48 moves back and forth with respect to teeth A-H as indicated on FIG. 4 and for as long as motor 36 is operational. Manual toothbrush 48 thereby simulates the brushing of the teeth A-H. When switch 22 is moved to the open position, the feedback circuit 32f is broken and microprocessor 34 causes the image of manual toothbrush 48 to disappear from display screen 26.

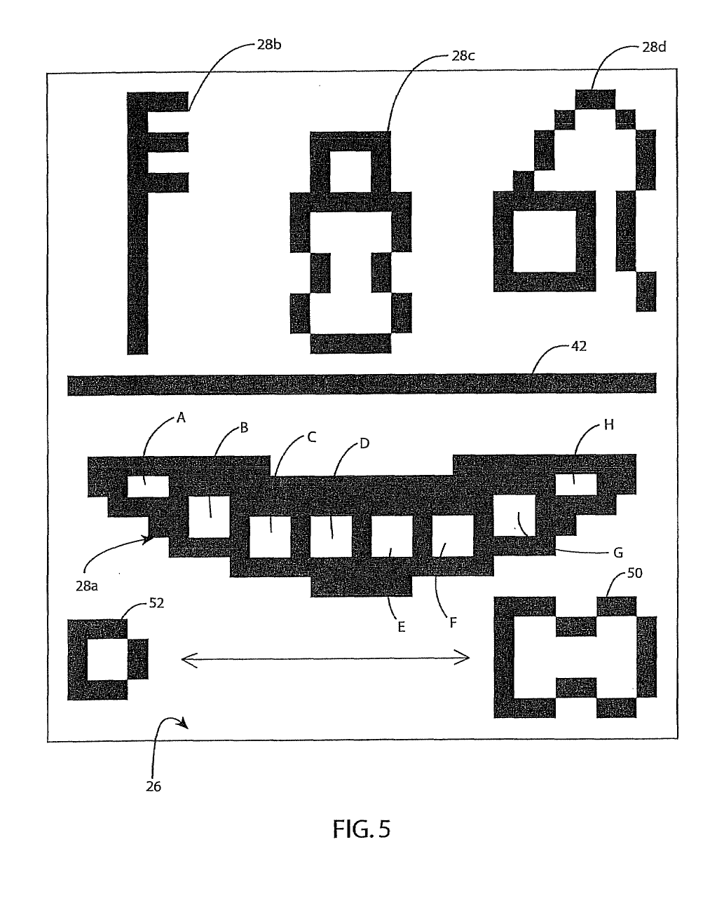

FIG. 5 shows display screen 26 when the play button 30b associated with mouthwash container 28c is depressed and released. Button 30b is depressed by the child when they have physically used mouthwash in that day's oral care. In response to button 30b being pushed, microprocessor causes a new image of a mouthwash container 50 and cap 52 to be displayed beneath line 42 and proximate the teeth A-H of smile 28a. Mouthwash container 50 is oriented on its side and cap 52 pops off the container 50 and moves back and forth as indicated. Cap 52 moves for a few seconds and then the images of both of mouthwash container 50 and cap 52 disappear from display screen 26.

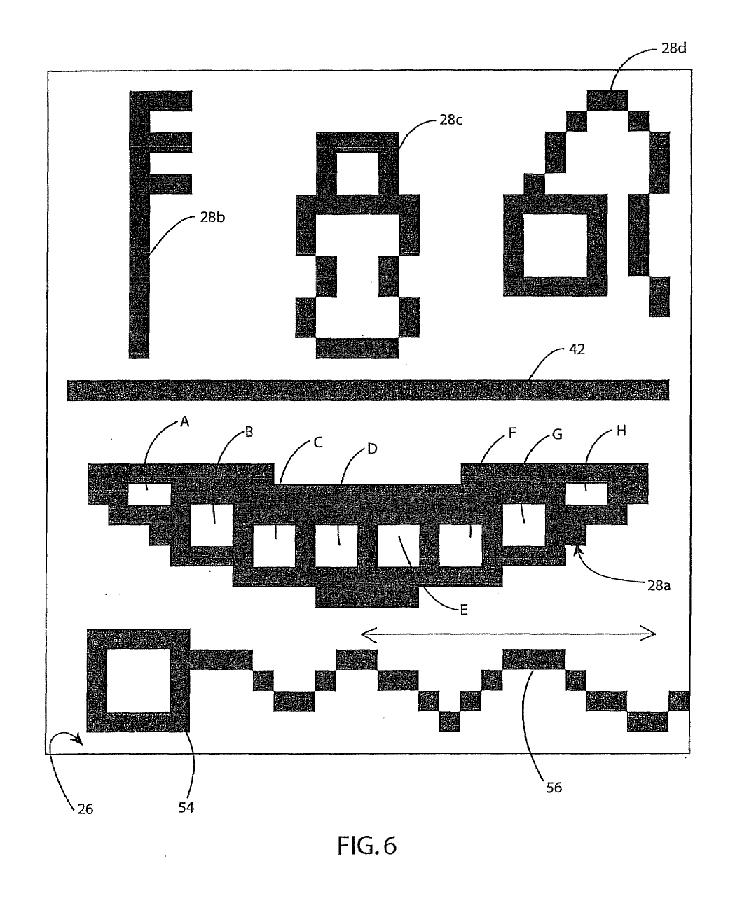

FIG. 6 shows display screen 26 when the play button 30c associated with dental floss 28d is pushed. The child will push play button 30c when they have physically used dental floss as part of their teeth cleaning regimen. The depression of button 30c causes microprocessor 34 to generate a new image of a dental floss container 54 and a length of floss 56 beneath smile 28a. Floss container 54 is disposed adjacent tooth A and floss 56 extends outwardly therefrom and moves back and forth as indicated in FIG. 6. This back and forth motion gives the illusion of the floss being pulled out of floss container 54 and then being drawn back into the same. The back and forth motion continues for a few seconds and then the floss container 54 and floss 56 disappear from the screen.

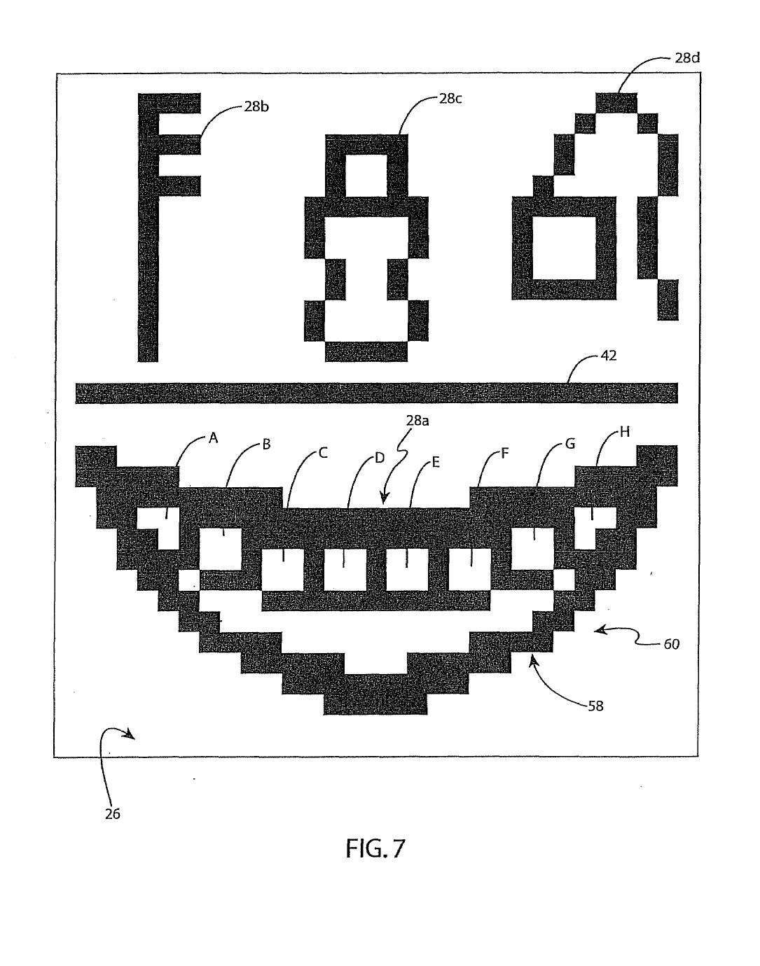

FIG. 7 is an illustration of display screen 26 if the child has faithfully followed a recommended dental care regimen over a set period of time such as twenty four hours or forty-eight hours. So, for example, if the child has, for a forty-eight-hour period, faithfully brushed their teeth twice a day for at least two minutes each time and has used at least one of dental floss and mouthwash over that two-day period, the microprocessor will cause the visual display on screen 26 to change to an enhanced image such as the big smile 60 shown in this figure. Big smile 60 is formed by the addition of a bottom lip 58 to smile 28a. When this big smile 60 is displayed on display screen 26 the gaming function in the microprocessor is activated and the child can play the fun games that are programmed into the microprocessor 34. Games are accessed and played using play buttons 30a, 30b, and 30c. If big smile 60 is not displayed on display screen 26, then none of the fun games are accessible. Big smile 60 only lasts for a twenty four hour period and then the bottom lip 58 disappears, leaving smile image 28a on display screen 26. Each day microprocessor resets to the standard smile 28a (FIG. 3) and thus requires all the teeth A-H to be present plus the use of the digital oral care tools in order for the child to be able to play any games on that day.

FIGS. 8 to 15 show a progressive display of the loss of “teeth” from smile 28a if the required cumulative minimum frequency and/or time of brushing is not reached by the child over a set time period, such as twenty four hours. If the minimum brushing frequency and length of time goal is not met, at least one of the teeth A drops out of smile 28a and falls down to the bottom of display screen 26. So, for example, FIG. 8 shows the display screen when the child has only met around 87.5% of the ADA's frequency and brushing time recommendation. Tooth “B” has dropped out of smile 28a and moved to the bottom of display screen 26 as blacked tooth B′. When tooth “B” drops out of smile 28a, the region of the smile 28a where tooth “B” was formally located, i.e., region 62, is darkened.

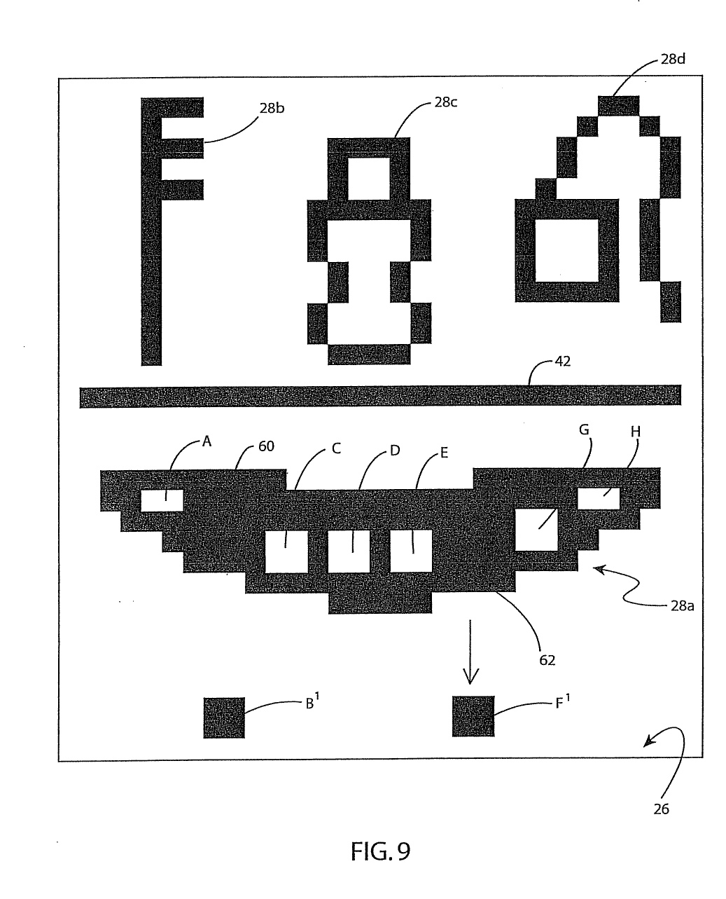

Similarly, FIG. 9 shows the display screen 26 when yet another “tooth”, being tooth “F” has dropped out of smile 28a because the recommended frequency and/or brushing time has not been met and the amount of actual run-time was less than in the instance of FIG. 8. So, for example, if the child only met around 75% of the ADA recommended frequency and brushing times, two teeth will drop out of the smile. This leaves two blackened areas 60 and 62 on smile 28a and two teeth B′ and F′ at the bottom of display screen 26. If the child improves their oral habits over the next twenty four hours and increases the frequency and length of brushing, one of teeth B′ or F′ will move back into smile 28a. A second day of good oral care where the minimum frequency and length of brushing goals are met will return the other of the teeth B′ and F′ back into smile 28a.

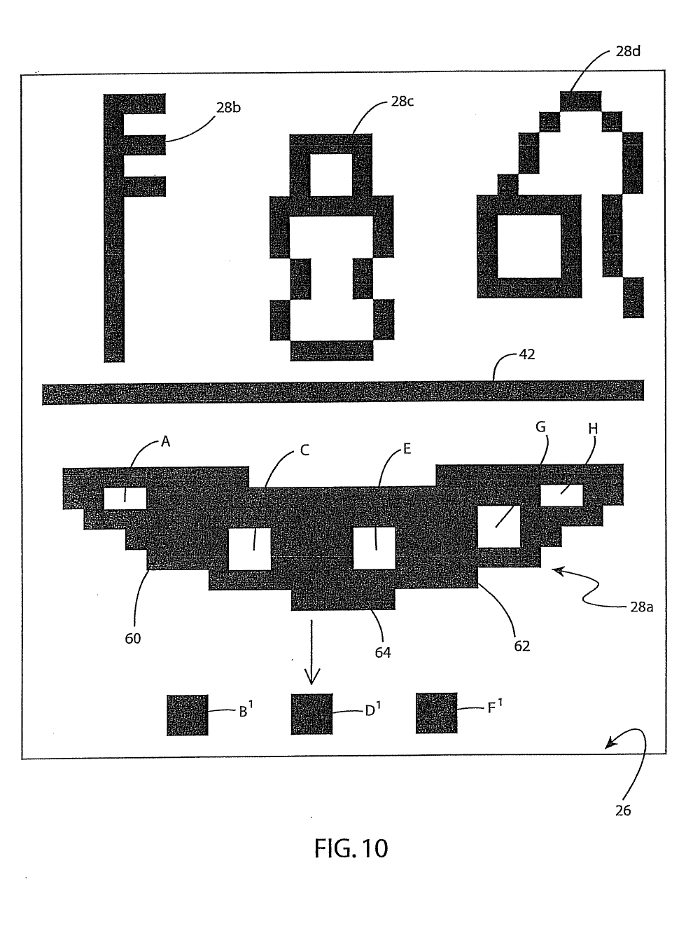

FIG. 10 shows the display screen 26 when yet another “tooth”, being tooth “D”, has dropped out of smile 28a because the recommended frequency and/or brushing time has not been met and the amount of actual run-time was less than in the instance of FIG. 9. So, for example, if the child only met around 62.5% of the ADA recommended frequency and brushing times, three teeth will drop out of the smile. This leaves three blackened areas 60, 62 and 64 on smile 28a and three teeth B′, D′, and F′ at bottom of display screen 26.

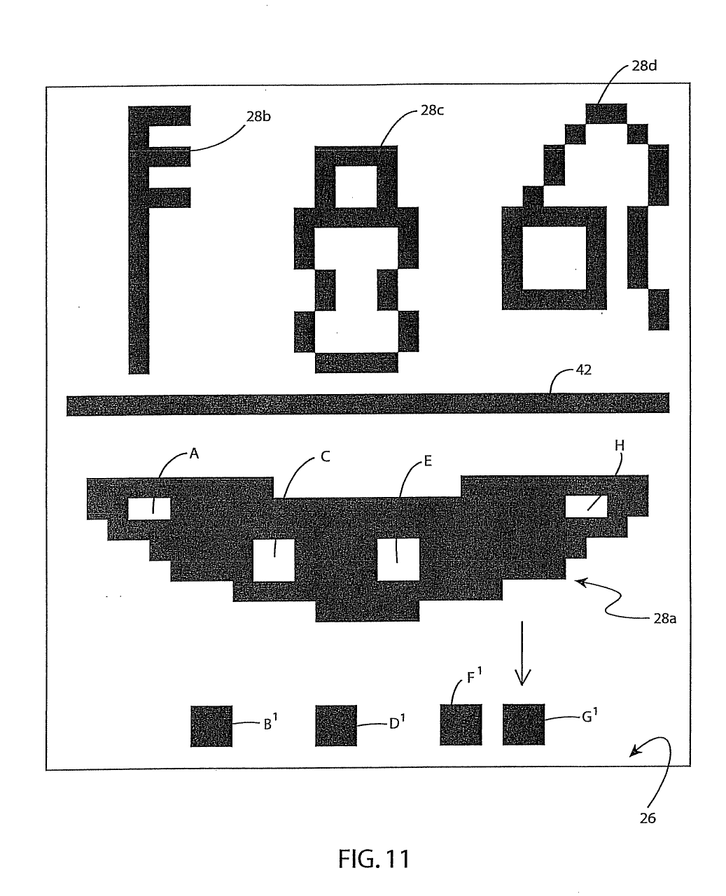

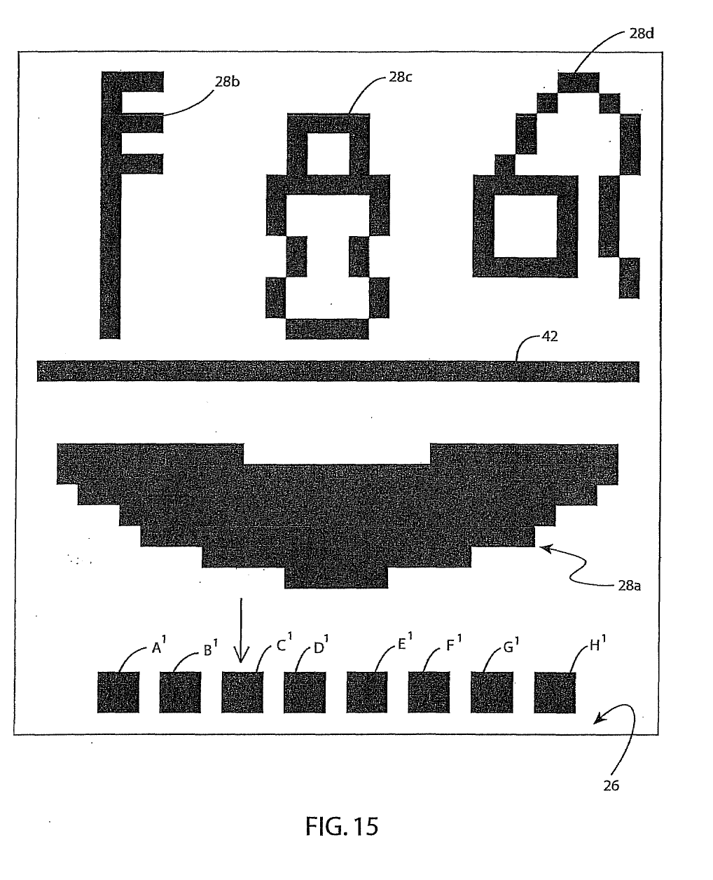

FIGS. 11 through 15 show the display screen 26 when the remaining teeth are progressively lost through failure to brush for the recommended frequency and/or length of time. Ultimately, as shown in FIG. 15, no teeth A-F are left in smile 28a and smile 28a is one large blackened or darkened region. All of the teeth have dropped out of smile 28a and are situated beneath smile 28a as teeth A′, B′, C′, D′, E′, F′, G′ and H′. The means that the child has essentially has not brushed their teeth at all that day.

It will be understood that instead of the microprocessor resetting smile 28a every twenty four hours, microprocessor 34 could be programmed to track oral care over a period of a week for example. At a touch of any button on toothbrush 10, a parent could determine the oral habits of their child over that time period. If the child is regularly not meeting the minimum daily recommendations for brushing, the teeth A-H could be progressively lost over that week long time period. The overall image of the blackened smile 28a with all of the teeth dropped out therefrom is an image that is clear enough for even a fairly young child to understand that they have not been brushing their teeth properly. The overall image is also a clear indication to a parent that more supervision of their child's oral care needs to be undertaken. Similarly, if over a week long period the child's brushing habits improve and the microprocessor causes the reincorporation of previously lost teeth A-H into the smile 28a, then the child will easily see that improved habits bring about improved results.

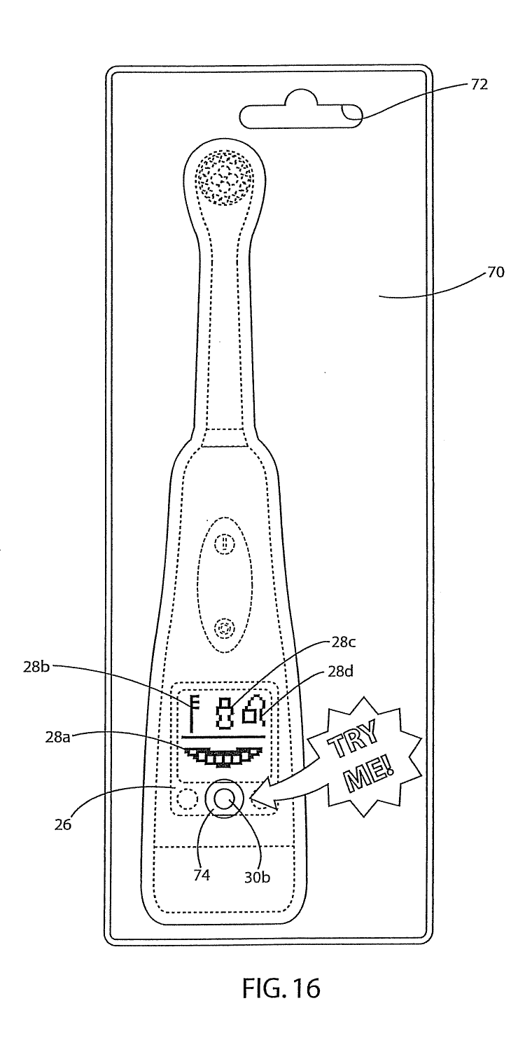

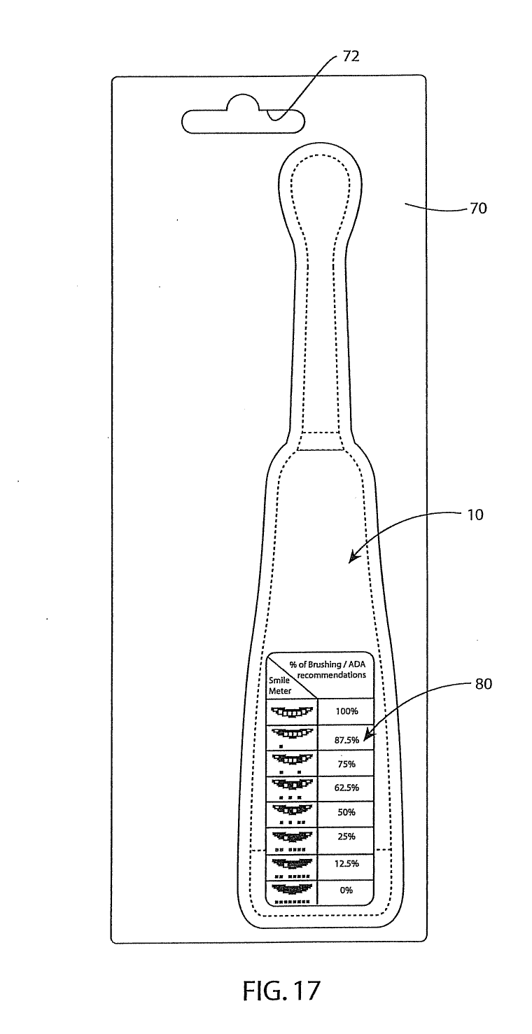

FIGS. 16 and 17 show an example of how the toothbrush 10 in accordance with the present invention could be packaged within a blister package 70. Package 70 includes an aperture 72 which will allow it to be hung on a display rod in a store. Package 70 also includes a second aperture 74 that is complementary located and sized to allow a potential consumer access to one of the play buttons, such as 30b. The potential consumer is able to depress play button 30b to play a portion of a game programmed into training aid 24. The game will be displayed on display screen 26 that is visible through the packaging. Packaging may also include product information that will advise parents as to the significance of the loss of the teeth A-H from smile 28a and how to monitor and encourage their child to improve their oral care habits. As shown in FIG. 17, a chart 80 or other explanatory text or illustrations may be placed on either the rear surface of toothbrush 10 or on package 70. For instance, chart 80 could indicate that one tooth missing from smile 28a indicates that the child has only met around 87.5% of the ADA recommendations. Two teeth missing represent 25% less than the ADA minimums and so on.

As mentioned previously, the goal of toothbrush 10 is to aid in motivating a child to increase the length of time they brush their teeth and to use additional dental tools and products to take care of their teeth. The picture type nature of images 28 makes it easy for even a young child to see whether their brushing habits are adequate or inadequate. The visual image of the loss of teeth when bad habits are followed will easily show the child they need to improve their brushing. The visual image of the maintenance of a full smile 28a or the display of the big smile 60 will encourage the child to keep up their brushing. The access to the fun games programmed into the device, will further serve to encourage the child to continue to brush their teeth properly and to use other oral care products. The presence of digital training aid 24 also enables a parent to monitor, verify and encourage regular brushing by providing a reliable indicator of their child's actual brushing habits over a more protracted period of time.

It will be understood by those skilled in the art that other features may be incorporated into toothbrush 10. Such features could include pressure or motion sensors installed adjacent bristles 12 and are operationally linked to microprocessor 34. Such sensors could be installed to substantially prevent a child from simply switching the motor 36 on to save their digital teeth A-H without actually physically brushing their teeth. The sensors would substantially prevent microprocessor 34 from recording an actual run-time of the motor in such instances. Microprocessor 34 could be programed to not save the teeth A-H unless pressure has been applied to the bristles 12 through the brushing motion. Yet other additional features may include a count-down timer that will enable the user to see how much time to continue brushing in a pre-determined two minute time period, as well as the provision of a mechanism for generating a sound when a two minute time period has elapsed.

The oral care tools 28b-28c expose the young users to more adult oral care products and help them to associate a regime such as flossing, toothpicks and mouthwash as part of regular oral care. Preferably all of the fun games programmed into the microprocessor 34 will have oral-care based themes or use oral care products as components of the game.

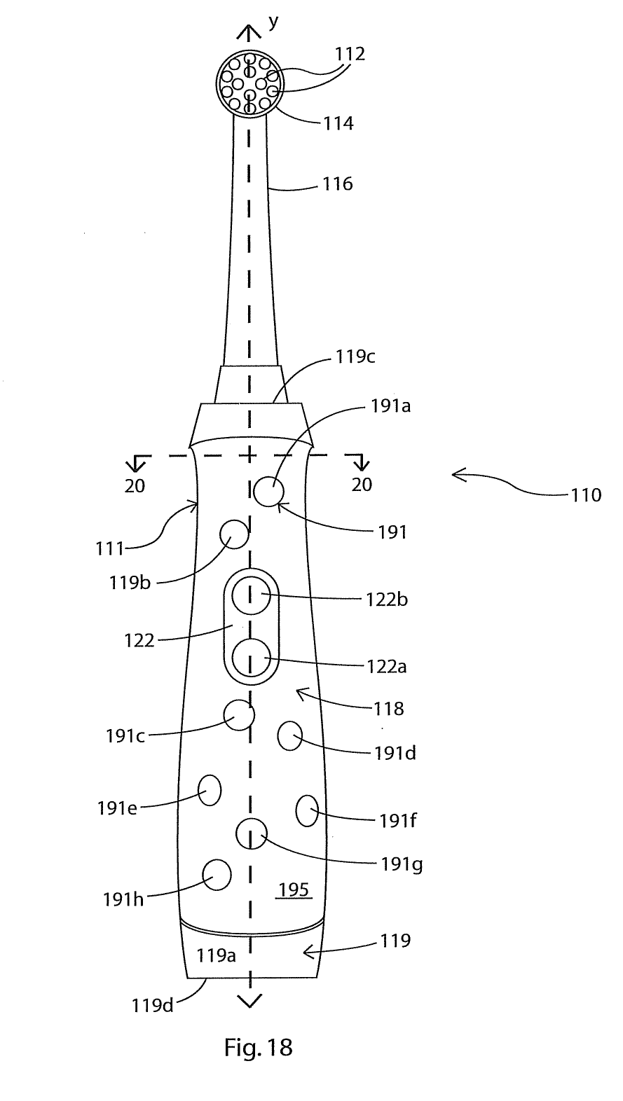

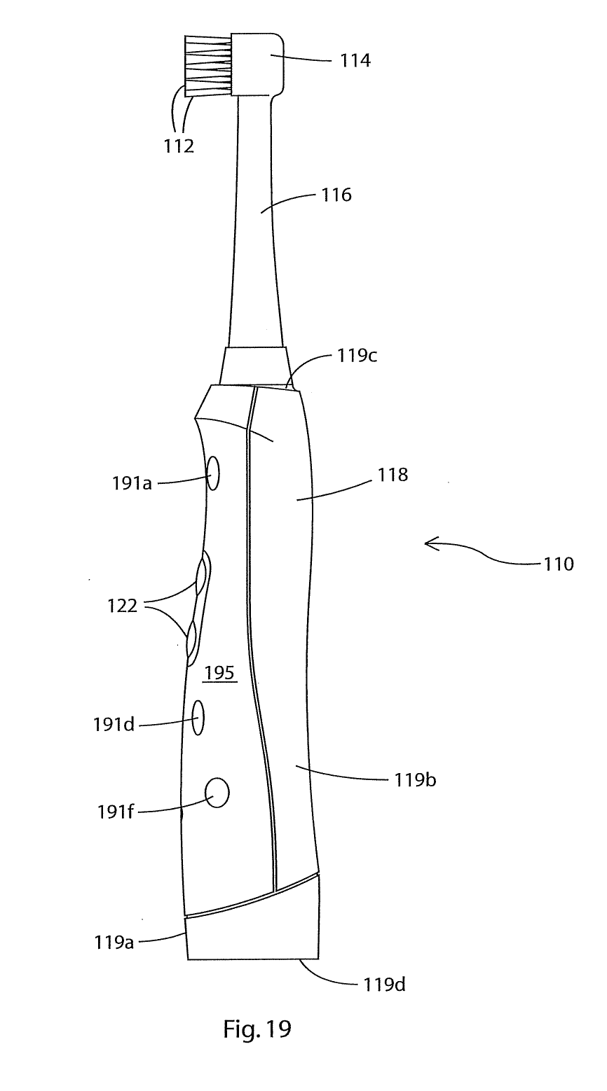

FIGS. 18-21 show a second embodiment of an electric toothbrush 110 incorporating a training aid in accordance with the present invention. Toothbrush 110 comprises a body 111 made up of a head 114, a neck 116 and a handle 118. A plurality of bristles 112 extend outwardly away from head 114 and substantially at right angles to a longitudinal axis “Y” of body 111.

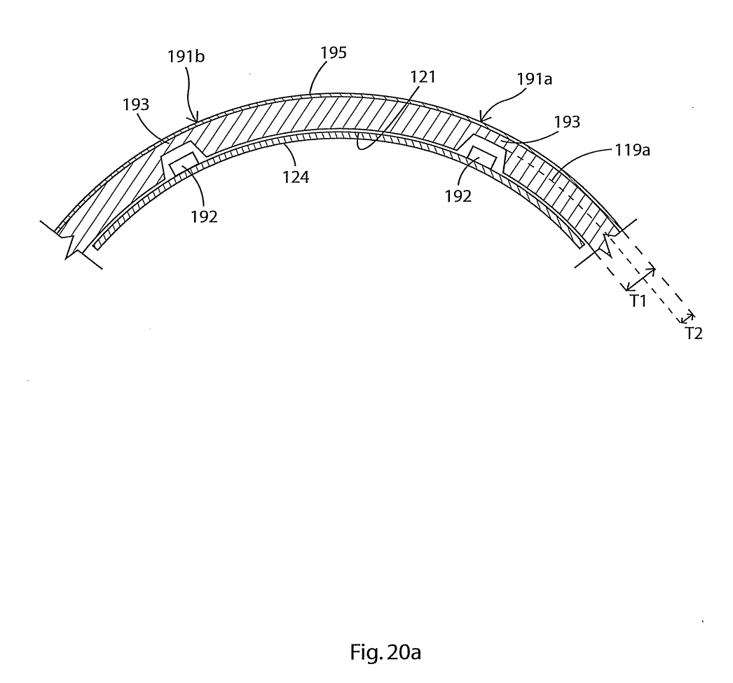

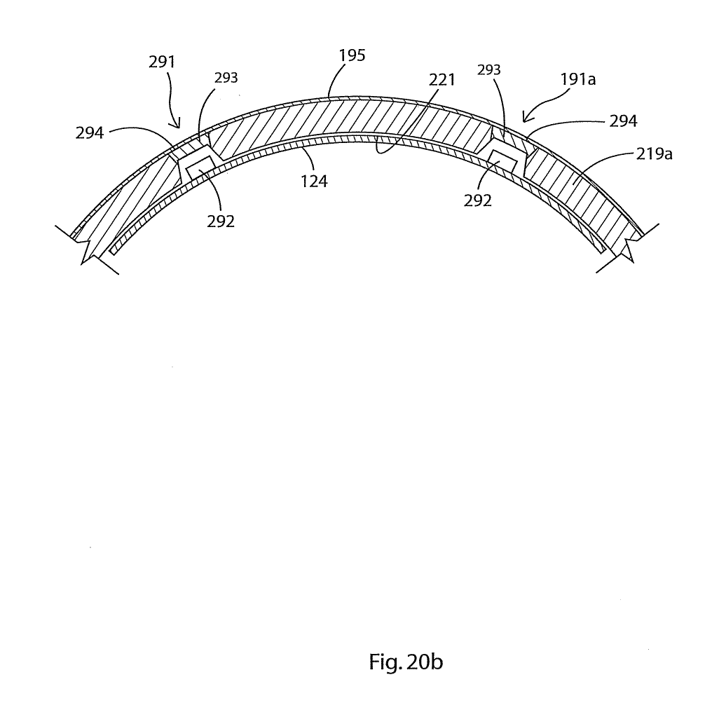

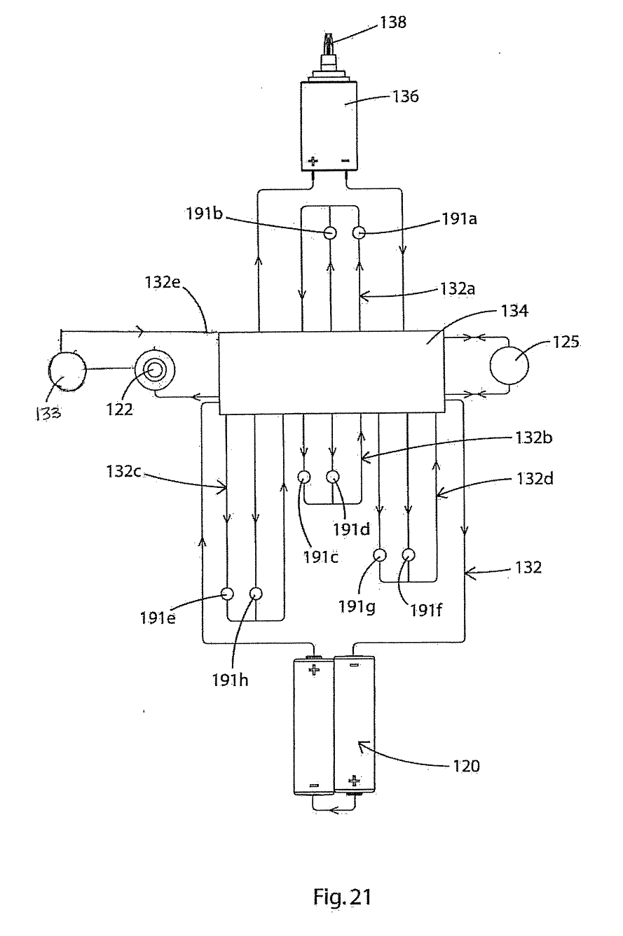

Handle 118 has an exterior wall 119 (FIG. 20) comprising a front 119a, a back 119b, a top end 119c and a bottom end 119d. Exterior wall 119 surrounds and defines a longitudinally aligned recess 121 therein. A number of components are housed within recess 121 and are shown on the block diagram in FIG. 21. These components include a power source 120, a microprocessor 134, a speaker 125 and a motor 136. Power source 120 may be any suitable device or mechanism that is able to supply power to toothbrush 110. Preferably, as shown in FIG. 21, power source 120 comprises one or more batteries. Microprocessor 134 is a printed circuit board that includes software for controlling various components of toothbrush 110 and for controlling a training aid as will be hereinafter described. Microprocessor 134 is operationally linked to power source 120, timer 133, off/on switch 122, motor 136 and speaker 125. All of these components are operationally connected together by an electrical circuit 132. Switch 122 is provided in circuit 132 to permit a user to activate and deactivate toothbrush 110.

Timer 133 is configured to track an actual brushing time for a brushing event. The prior art has described a number of different types of timers. Some of these timers are run-down type timers that have a pre-set period of time that counts down to zero. Other timers start at zero and count up to a pre-determined time and then automatically shut off. Yet other timers are linked to sensors in the bristles and every time bristle-contact with the teeth is broken. The timer ceases to count. Any one of these timers may be incorporated into toothbrush 110 as timer 133. Preferably, however, timer 133 is operationally linked to switch 122 and motor 136. When the switch 122 moved to close the circuit 132, then motor 136 is actuated and the timer 133 starts tracking time. When switch 122 is moved to open circuit 132, then motor 136 is stopped and the timer 133 stops tracking time. The actual brushing time is computed as the length of time from when the motor 136 starts to when the motor 136 stops.

In accordance with a specific feature of the present invention, toothbrush 110 is provided with a training aid for encouraging users, especially younger children, to brush their teeth consistently and for a sufficient period of time. This training aid includes an indicator that provides the user of toothbrush 110 with indicia of the degree of brushing compliance they have attained over a pre-set period of time. The indicator comprises a plurality of light assemblies 191 provided in handle 118 and is operated by microprocessor 134. Specifically, microprocessor 134 illuminates one or more of light assemblies 191 as the indicator to the user.

In the preferred embodiment of the invention, a plurality of light assemblies 191 are provided in handle 118. Specifically, eight light assemblies 191 are provided in the front 119a of exterior wall 119 between the top end 119c and bottom end 119d. Preferably, the plurality of light assemblies 191 are arranged in an aesthetically pleasing pattern arrayed around on/off switch 122. The light assemblies are located in this region of toothbrush 110 as it faces the user during use and is easily seen when the user depresses the on/off buttons of switch 122 to activate toothbrush 110.

FIG. 18 shows eight light assemblies 191 arranged in a pattern around switch 122 but it will be understood that any number of light assemblies 191 may be arranged in any aesthetically pleasing pattern on handle 118. The eight light assemblies are identified as assemblies 191a, 191b, 191c, 191d, 191e, 191f, 191g and 191h. Each light assembly 191 comprises a light-emitting diode (LED) 192 and a lens assembly 193. The LEDs 192 are operationally linked to microprocessor 134 and to power source 120 as shown in FIG. 21. Preferably, pairs of light assemblies are wired in parallel with each other into sub-circuits that are then wired to microprocessor 134 in parallel with each other. So, as illustrated in this figure, light assemblies 191a and 191b are wired in parallel to each into sub-circuit 132a; light assemblies 191c and 191d are wired in parallel into sub-circuit 132b; light assemblies 191e and 191h are wired in parallel into sub-circuit 132c and light assemblies 191f and 191g are wired in parallel into sub-circuit 132d.

The lens assembly 193 of each light assembly 191, permits the light emitted from LED 192 to be seen by the user. Lens assembly 193 may be provided on toothbrush 110 in a number of ways. In a first instance, lens assembly 193 is an integral part of front 119a of exterior wall 119. As shown in FIG. 20a, front 119a of the exterior wall is manufactured from a material that is of a first thickness “T1”. This material is thinned in various pre-determined locations to a second thickness “T2”. Second thickness “T2” is substantially thinner than first thickness “T1”. Each thinner location comprises one of the lens assemblies 193 for light assemblies 191. In the preferred embodiment of the invention, front 119a of handle 118 is molded from a plastic material that has a first thickness T1 of 0.06 inches and the lens assemblies 193 are of a second thickness of 0.015 inches. Preferably, the plastic material is dark in color and is transparent, semi-transparent or translucent. Because of the relative thinness of the lens assemblies 193, light emitted from the LED 192 adjacent each lens assembly 193 will be visible from outside of handle 118 only in the regions of the lens assemblies 193. This arrangement creates a plurality of fairly large illuminated areas on the front 119a of handle 118. The thickness of the rest of front 119a substantially prevents any light from the LEDs from being seen other than in the regions of the lens assemblies.

FIG. 20b shows a second alternative version of a front 219a of the exterior wall of the handle 118. Front 219a is provided with a plurality of apertures 294 therein, The apertures 294 are defined in locations corresponding to where the LEDs are to be situated on the handle of the toothbrush. A lens assembly 293 is sealingly engaged in each aperture 294 in such a manner that liquid cannot enter the recess 221 of the handle 118. Each lens assembly 293 is a translucent or transparent disc of material that permits light from the LED 292 adjacent thereto to shine therethrough and to therefore be visible outside of the toothbrush 110. Each lens assembly 293 and adjacent LED 292 constitutes one of the light assemblies 291 in the handle.

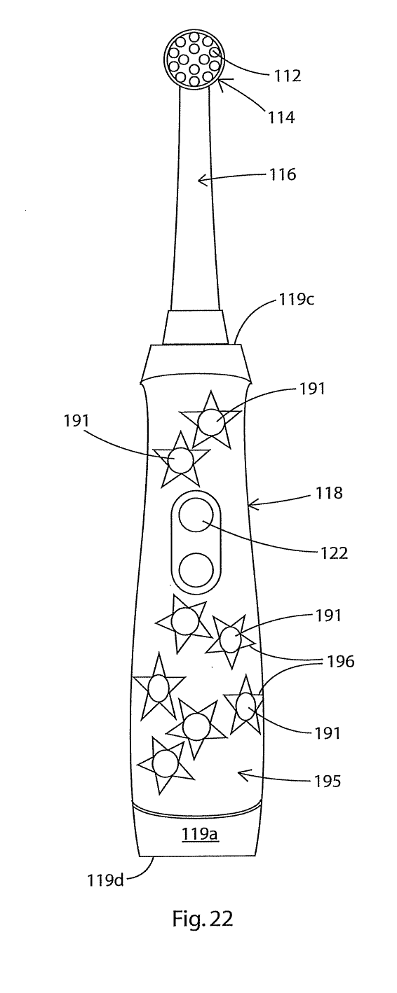

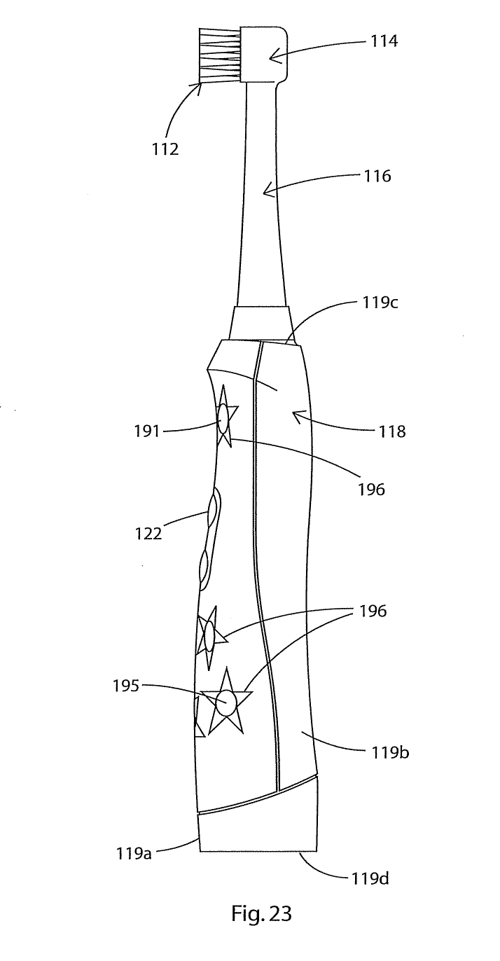

As shown in FIGS. 22 and 23 and in accordance with yet another feature of the present invention, toothbrush 110 is provided with a decorative overlay 195 that is applied to at least a portion of the exterior surface of handle 118. Preferably, overlay 195 is applied to front 119a of handle 118 and extends from proximate top end 119c of exterior wall 119 to proximate bottom end 119d thereof. Specifically, overlay 195 is applied to that portion of the exterior surface of front 119a of handle 118 that includes the light assemblies 191. Overlay 195 preferably comprises a thin, plastic sheet which includes a plurality of aesthetically appealing graphic images 196 (FIG. 22) thereon. These graphic images 196 may take any form that will be appealing to children. For example, and as is illustrated in FIGS. 22 and 23, the graphic images 196 may be those of a plurality of stars. Alternatively, the graphic images may be cars, space craft, television characters and personalities, singers, film and television stars, etc. The regions of the overlay 195 surrounding graphic images 196 may be transparent, translucent, or opaque. The graphic images may be colored and the regions surrounding the same may be colored or colorless. One or more, or all of the graphic images 196 may be provided on overlay 195 in positions that will cause at least a portion of at least one of the images 196 to be aligned with or disposed adjacent to at least one of light assemblies 191. Thus, when any of the light assemblies 191 are illuminated, the light from the LED 192 associated therewith shines through lens assembly 193 and through the graphic image 196 disposed thereover thereby drawing attention to image 196 and enhancing the same.

It will be understood that toothbrush 110 may further include a sound-generating or emitting device, such as speaker 125 (FIG. 21) that is operationally connected to microprocessor 134 and the light assemblies 191. The software carried by the microprocessor 134 may also cause a sound bite to be generated from speaker 125 as part of the indicator to the user of the degree of brushing compliance attained in the pre-set period of time. Speaker 125 may be configured to generate sounds when toothbrush 110 is being used to brush teeth or may be used to generate sounds after a certain actual brushing time has been attained. Speaker 125 may generate sounds that correspond with the graphic images 196 displayed on the overlay 195. For example, if the graphic images 196 are likenesses of a pop-idol, then the speaker could generate sound bites of that artist singing. If the graphic images 196 are automobiles, the speaker 125 generates sound bites of revving engines, and so on.

Referring to FIGS. 18-21, toothbrush 110 is used in the following manner. The manufacturer determines a pre-set period of time and programs software to be carried by microprocessor 134 accordingly. In the preferred embodiment of this invention, that means that a pre-set time period of between 8 and 72 hours is programmed into the software. Preferably, that pre-set time period is selected to be 48 hours long. The pre-set period of time selected determines the preferred brushing time for that pre-set period of time. It is currently recommended that a desirable minimum brushing time during any single brushing event be two minutes long. Thus the preferred brushing time programmed into the software is based on a two minute brushing time per brushing event. Thus, if the pre-set period of time is determined to be 8 hours long and two brushing events are anticipated during that 8 hour period, the preferred brushing time for that time period would be 4 minutes. Similarly, if the pre-set period of time is set at 48 hours and four brushing events are anticipated to be tracked during that time period, then the preferred brushing time would be set at 8 minutes. The software carried by the microprocessor is programmed with this information. Additionally, a minimum level of brushing compliance is provided in the software. Only if that minimum degree of brushing compliance is attained will the microprocessor operate the indicator to advise the user of the level of brushing compliance attained over the pre-set period of time.

When the user comes to brush their teeth in a first brushing event of the pre-set time period, they engage the on-button 122b of switch 122 thereby closing circuit 132 (FIG. 21). Since circuit 132 links microprocessor 134, power source 120, timer 133, motor 136 and switch 122, the motor 136 is started. Motor 136 causes motion in a drive shaft 138 that extends outwardly from motor 136. Although not illustrated herein, drive shaft 138 is operationally connected to any suitable mechanism for causing motion in bristles 112. The closing of circuit 132 also starts timer 133. When the user is finished brushing their teeth, they engage the off button 122a of switch 122, thereby opening circuit 132 and stopping motor 136. Timer 133 measures a first actual brush time from the starting of motor 136 to the stopping of motor 136. This first actual brush time is stored by the software carried by microprocessor 134.

Some time later in the pre-set period of time the user decides to brush their teeth again. This second brushing event is successive to the first brushing event. Once again, when the motor 136 is started the timer 133 starts tracking actual brushing time and when the motor stops, the timer stops tracking actual brushing time. The software carried by microprocessor 136 adds this second actual brushing time for the second brushing event to the first actual brushing time to arrive at a total brushing time for the two successive brushing events. If the pre-set period of time only requires two successive brushing events to be monitored, then the software compares the total actual brushing time for both of these brushing events over the pre-set period of time with a predetermined preferred brushing time. This comparison is made by dividing the total actual brushing time by the preferred brushing time to arrive at the degree of compliance for that pre-set period of time. The microprocessor then operates the indicator to advise the user of the degree of compliance attained over that pre-set period of time.

If the user brushes their teeth an additional time beyond the initial pre-set period of time then the software resets the pre-set period of time by deducing the first actual brushing time from the total actual brushing time so as to obtain an adjusted actual brushing time. So, for instance, if the pre-set period of time was selected to be 48 hours long and the user brushes their teeth for the very first time with the brush at the beginning of a 48 hour period and then brushes their teeth again at intervals during the first 48 hours of using the toothbrush, then at the end of that 48 hours, the microprocessor will indicate to the user the degree of compliance during that first 48 hour period. The next time the user brushes their teeth will fall automatically outside that initial 48 hour period. The toothbrush is designed to only monitor the 48 hour period that immediately precedes the current brushing event. Consequently, the software will automatically reset the pre-set period of time to 48 hours by deducing the first actual brushing time from the total actual brushing time so as to obtain an adjusted actual brushing time. The timer tracks the actual brushing time for the current brushing event and that time is then added by the software to the adjusted actual brushing time to arrive at a revised total actual brushing time. The software then compares the revised total actual brushing time with the predetermined preferred brushing time for the pre-set period of time to arrive at a revised degree of brushing compliance. In other words, the software automatically only includes the actual brushing times of brushing events that occur during a pre-set period of time and automatically excludes the actual brushing times of brushing events that fall outside the pre-set period of time. The user is thus kept appraised only of their degree of brushing compliance in the preceding pre-set period of time and no further back than the start of that pre-set period of time. This mode of operation will be repeated a plurality of times until the useful life of the toothbrush 110 is over.

The software adds the successive actual brushing times together to obtain a total actual brushing time for the pre-set period of time. The software then compares that total actual brushing time with a pre-determined preferred brushing time for that pre-set period of time in order to determine the degree of brushing compliance by the user. For, example, if the pre-set period of time is set at 48 hours, then the preferred brushing time may be set at 8 minutes. This 8 minute period would represent four separate and successive brushing events during that 48 hour period. This number of brushing events would represent the user brushing their teeth in the morning and evening of each 24 hour period. Alternatively, if it is desired to increase the number of times that a user brushes their teeth in that 48 hour period, morning, noon and night, for example, then the preferred brushing time could be set at 12 minutes. The 12 minutes preferred brushing time would represent 6 successive brushing events during the 48 hour period.

As mentioned previously, the software is programmed to determine the degree of brushing compliance by the user during the pre-set period of time. The degree of brushing compliance is determined by dividing the total actual brushing time for the pre-set period of time by the preferred brushing time for that pre-set period of time. Inasmuch as the toothbrush 110 is designed for use over a long period of time that extends beyond 8 hours, 48 hours or 72 hours, the software is programmed to continuously adjust the data so that it records and displays an indicator that will let the user know the degree of brushing compliance only from the pre-set period of time. Consequently, the software will automatically include the actual brushing time of any brushing event within the pre-set period of time and will automatically delete the actual brushing time of any brushing event that occurs outside of the pre-set period of time. The software preferably is also programmed not to record more than two minutes of actual brushing time in any three-hour period. This eliminates the possibility of false scores of brushing compliance by the user merely playing with the toothbrush 110.

After any one of the brushing events in that forty-eight-hour period when the user has brushed their teeth, the software in microprocessor 134 operates an indicator to advise the user of the degree of brushing compliance. In accordance with the present invention, that indicator includes illuminating one or more of the light assemblies 191. More particularly, the light assemblies 191 are illuminated in a flashing pattern. The indicator is proportionate to the degree of brushing compliance over the pre-set period. So, for example, in a 48 hour period, if the user brushes their teeth for 4 minutes out of a preferred brushing time of 8 minutes, then the degree of brushing compliance is 50% and microprocessor 134 illuminates 50% of the light assemblies 191. So, if there are 8 light assemblies, then four of them are illuminated. If the user brushed their teeth for five minutes of the preferred eight, then five of the light assemblies 191 will be illuminated. Essentially, one additional light assembly 191 is illuminated for each additional minute of actual brushing time. If there is 100% brushing compliance and the user brushed their teeth for all eight minutes of the preferred time of eight minutes, then all of the light assemblies 191 are illuminated.

It is easy for the user to determine the degree of brushing compliance that they have achieved over the forty-eight-hour pre-set period of time by viewing the indicator response generated by the microprocessor. This can be done by counting the number of illuminated light assemblies on the body and/or counting the number of non-illuminated light assemblies on the body. That counted number can then be compared with the total number of light assemblies provided on the body to see the degree of compliance attained. If for example three of the eight light assemblies 191 are not illuminated, then the user (or the parent of the user) can easily determine that three out of the preferred eight minutes of brushing time were not attained. (Since five of the light assemblies 191 are illuminated, the user obviously attained five of the preferred eight minutes of brushing time.) It is therefore very easy for even the youngest user to see that they have not brushed for long enough and for the parent to determine what the actual difference is in actual brushing time relative to preferred brushing time over that last forty eight hours.

As mentioned previously, light assemblies 191 preferably are illuminated in a flashing pattern. This pattern changes in complexity and increases in flashing speed with each additional light assembly 191 that is illuminated. Consequently, the slowest, least complex flashing pattern is displayed when brushing compliance is low and the fastest, most complex and interesting flashing pattern is exhibited by the light assemblies when there is one-hundred percent brushing compliance.

Additionally, the indicator response generated by microprocessor 134 may include the playing of a sound bite that is broadcast through speaker 125. The generated sound bite may be synchronized with the flashing pattern of the light assemblies 191. Microprocessor 134 may be programmed so that during brushing, some or all of the light assemblies 191 flash in a standard pattern. Similarly, a standard sound bite may be played during brushing or the toothbrush may be silent. Then, when the user switches the toothbrush off, there may be a delay of one second for example, and then the reward illumination and sound bite are generated by the microprocessor 134. The flashing pattern and the accompanying sounds are generated for a pre-set length of time, such as two seconds, and then the toothbrush switches itself off.

It will be understood that although the preferred embodiment of the toothbrush has been shown to have light assemblies 191 in the handle 118 only, toothbrush 110 may be configured to include one or more light assemblies on the neck 116 or even on the head 114 of the brush. Additionally, light assemblies 191 may be provided in regions of the toothbrush 110 other than the front 119a.

Furthermore, while the preferred embodiment of the toothbrush has been described as an electric toothbrush where a motor causes motion in the bristles, the toothbrush may, instead, be a manual toothbrush. Such a manual toothbrush would not include a motor to generate motion in the bristles but may, instead, be provided with a motion sensor. The motion sensor could be operationally linked to the microprocessor or to the timer to permit tracking of actual brush time. The power source and microprocessor in such a manual brush would then be provided simply to generate a indicator response for aiding the user to improve the degree of brushing compliance. The manual toothbrush could be provided with on/off buttons that would be used to activate the microprocessor or the initiation of motion in the brush could activate the microprocessor.

It will be further understood that the neck 116, head 114 and bristles 112 may constitute a replaceable brushhead that is detachably engaged with handle 118. As is known in the art, bristles 112 may be provided with indicator colors that fade with usage and let the user know when the brushhead as served out its useful life. The brushhead may then be detached from the handle 118 and a new brushhead may be engaged therewith. In this way, whether the brushhead is powered or manual, the handle 118 with the training aid 190 therein may be utilized for a longer period of time and with numerous brushheads.

It will also be understood that this design permits a manufacturer to apply a wide variety of overlays with different graphics onto the same basic handle design without requiring retooling of the handle for each different overlay design. The variety of overlays 195 will each simply include different graphic images 196 that are located at substantially the same positions on the overlay so that at least one, and preferably all, of the graphic images 196 thereon will be disposed adjacent to one of the light assemblies 191 when the overlay is applied to the handle and adjacent the light assemblies. Obviously, if the light assemblies are also provided on the neck of the brush, then the overlay will extend to that area. Similarly, if the light assemblies are also provided on the back 119b of the brush, then the overlay with its graphic images will be disposed adjacent that area of the toothbrush as well. The graphic images 196 on the overlay 195 are designed to be aesthetically appealing when the toothbrush is not activated but are further designed to be even more aesthetically appealing when the light assemblies 191 are illuminated.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A toothbrush comprising:
a body with a head at one end;
a plurality of bristles provided on the head and extending outwardly away therefrom;
a power source;
a microprocessor operationally linked to the power source;
a timer operationally linked to the microprocessor, said timer being configured to track an actual brushing time for a brushing event;
an off/on switch operationally connected to the timer for indicating the actual runtime;
software carried by the microprocessor; and wherein said software tracks the actual brushing times for a plurality of successive brushing events over a pre-set period of time.

2. The toothbrush as defined in claim 1 further comprising:
software to add the actual brushing times together to obtain a total actual brushing time for the pre-set period of time, and compares the total actual brushing time with a preferred brushing time to determine the degree of brushing compliance by the user.

3. The toothbrush as defined in claim 2 in which the timer tracks the actual brushing time over at least two successive brushing events.

4. The toothbrush as defined in claim 2, wherein the software carried by the microprocessor tracks the actual brushing times for a plurality of brushing events in the range of from 8 to 72 hours.

5. The toothbrush as defined in claim 4, wherein the software carried by the microprocessor tracks the actual brushing times for a plurality of brushing events over 48 hours.

6. The toothbrush as defined in claim 3, wherein the software carried by the microprocessor tracks the actual brushing time for four successive brushing events.

7. The toothbrush as defined in claim 3, wherein the software compares the total actual brushing time with a preferred brushing time of eight minutes for four successive brushing events.

8. The toothbrush as defined in claim 1, wherein the software automatically includes the actual brushing time of any brushing event within the pre-set time period and automatically deletes the actual brushing time of any brushing event that occurs outside of the pre-set time period.

9. The toothbrush as defined in claim 1, wherein the toothbrush further comprises:
a motor operationally connected to the bristles whereby actuation of the motor causes motion in the bristles, and wherein the timer is operationally connected to the motor to measure the actual length of brushing time from when the motors starts to when the motor stops.

10. The toothbrush as defined in claim 2, further comprising an indicator for providing the user indicia of the degree of brushing compliance determined by dividing the total actual brushing time by the preferred brushing time; and wherein the indicator response provided to the user is indicative of the degree of brushing compliance attained by the user over the pre-set period of time.

11. The toothbrush as defined in claim 10, wherein the indicator comprises at least one light assembly provided on the body; and wherein the microprocessor operates the at least one light assembly as the indicator.

12. The toothbrush as defined in claim 11, wherein the indicator comprises a plurality of light assemblies provided on the body; and wherein the microprocessor illuminates one or more of the plurality of light assemblies as the indicator.

13. The toothbrush as defined in claim 12, wherein the apparatus comprises eight light assemblies provided on the body of the toothbrush, and the software carried by the microprocessor tracks a plurality of successive brushing events over the pre-set period of time; and compares the actual brushing time over the successive brushing events with the preferred brushing time of eight minutes and illuminates an additional one of the eight light assemblies for each additional minute of actual brushing time accumulated over the pre-set time period.

14. The toothbrush as defined in claim 10, further comprising:
an overlay applied adjacent at least a portion of the body of the toothbrush; and
at least one graphic image provided on the overlay, and wherein at least a portion of the graphic image is provided in a position so as to be disposed adjacent at least one of the plurality of light assemblies.

15. A method of increasing tooth brushing compliance comprising:
a) providing a toothbrush having a body including a head with bristles extending outwardly therefrom, a microprocessor, a timer and a power source;
b) determining a pre-set period of time;
c) timing a first actual brushing time for a first brushing event during the pre-set period of time;
d) storing the first actual brushing time;
e) timing a second actual brushing time for a second brushing event successive to the first brushing event during the pre-set period of time;
f) adding the second actual brushing time to the first brushing time to obtain a total actual brushing time;
g) storing the total actual brushing time;
h) comparing the total actual brushing time for all of the brushing events over the pre-set time period with a predetermined preferred brushing time so as to obtain a degree of brushing compliance.

16. The method as defined in claim 15 including the further step of:
repeating the steps of timing an actual brushing time and adding that actual brushing time to the total actual brushing time for each of a plurality of successive brushing events subsequent to the second brushing event until the pre-set period of time has elapsed.

17. The method as defined in claim 16, wherein the step of determining a pre-set period of time comprises programming the microprocessor to track and store data over a period of time in the range of from 8 to 72 hours.

18. The method as defined in claim 15, further comprising the steps of:
aa) resetting the pre-set period of time by deducting the first actual brushing time from the total actual brushing times so as to obtain an adjusted actual brushing time;
bb) brushing the teeth during an additional successive brushing event;
cc) timing an additional actual brushing time for the additional brushing event;
dd) adding the additional actual brushing time to the adjusted actual brushing time to obtain a revised total actual brushing time;
ee) comparing the revised total actual brushing time with the preferred brushing time so as to obtain a revised degree of brushing compliance; and
ff) repeating steps aa) to ee) a plurality of times.

19. The method as defined in claim 15, further comprising the step of:
generating an indicator response based on the degree of brushing compliance.

20. The method as defined in claim 19, including the further steps of:
determining if a minimum level of brushing time has been met;
only activating the indicator means if the determining step shows that the minimum brushing time has been met.

21. The method as defined in claim 20, wherein the step of generating the indicator response includes illuminating one or more of a plurality of light assemblies on the body of the toothbrush.

22. The method as defined in claim 21, wherein the step of generating the indicator response includes illuminating one additional light assembly of the plurality of light assemblies for each minute of actual brushing time in the total actual brushing time.

23. The method as defined in claim 22, wherein the step of includes automatically including the actual brushing time of any brushing event within the pre-set period of time and automatically deleting the actual brushing time of any brushing event that occurs outside of the pre-set period of time.
